(19) United States
(12) Patent Application Publication
(10) Pub. No.: US 2008/0261174 A1
(43) Pub. Date: Oct. 23, 2008

(54) Expanding Ball Lock Oral Prosthesis Alignment Apparatus

(76) Inventor: Neal B. Gittleman, Houston, TX (US)

Correspondence Address: EZRA L. SCHACHT, 1620 WEST MAIN STREET, HOUSTON, TX, 77006-4712, US

(21) Appl. No.: 11/738,661

(22) Filed: Apr. 23, 2007

(51) Int. Cl. A61C 13/12

(52) U.S. Cl. 433/172

(57) ABSTRACT

A dental prosthetic alignment apparatus simultaneously corrects all vertical, parallel and angular misalignments between several abutments and their matching substructure sleeves in a multi-implant prosthesis.

### BACKGROUND OF THE INVENTION

Modern dental practices, seeking economies of time at the patient's side and in the laboratory, tend to provide completed and installed implant prosthesis in as few as a single sitting. Three dimensional images displayed and manipulated on a computer screen are derived from a CAT scan (Computer Aided Tomography) of all oral structures. Virtual implants and prosthetics are tried in this virtual space until a best case is developed. The number and type of implants, their placement angles and depths, the density of bone and the avoidance of critical structures are tested in this virtual space. Surgical drilling and implant registration guides are generated with Rapid Prototyping tools to insure an almost exact relative placement of a set of implants.

Nonetheless, minor deviations and anatomical requirements can prevent the parallel alignment of implants and the matching abutments with the final prosthesis. Under these circumstances, additional laboratory procedures such as cutting and welding to correct the undercase must be done to fit the prosthesis. One solution suggested is to provide an abutment having a smaller mating end resulting in a gap between the abutment and prosthesis for cementing, referred to as the CAL technique. In the CAL technique, a disposable shim is slipped between each abutment and substructure sleeve to make a gap to compensate for misalignment.

Izador Brajnovic in U.S. Pat. No. 7,175,434 teaches an expandable cylinder to fill the gap between the distal end of the abutment and the substructure sleeve of the undercase of the prosthesis. This is a partial solution still requiring parallel placement of abutments. Charles D. Kownacki in U.S. Pat. No. 5,302,125 offers a ball-in-socket adjustment within the upper end of the implant, leaving the distal end of abutment unmodified. This offers compensation for angular misalignment without addressing parallel displacement or vertical discrepancies of the abutments. The Kownacki placement of the ball-in-socket below the soft tissue invites bacteria and can compromise good oral hygiene.

The current invention addresses both the parallel and angular displacement of the axis between abutments with the same mechanism. The apparatus resides above the soft tissue and avoids oral hygiene and adjustment difficulties. The current invention has a water-tight gasket. This apparatus works equally well with prosthetics built with standard laboratory techniques. This invention solves the last sub-millimeter misalignment problem.

The avoidance of peri-implant bone loss and soft tissue inflammation requires an unstressed fit along with a smooth transition through the soft tissue. Impervious seals are necessary to prevent microbial encroachment. This apparatus addresses all of these requirements.

In the preferred embodiment of this invention, several degrees of freedom of motion for near perfect alignment are incorporated in a simple to install and adjust apparatus. Laboratory reworking and chair-side adjustments are reduced substantially or eliminated entirely.

### A BRIEF DESCRIPTION OF THE DRAWINGS

FIG. 1 is a cross sectional view of a ball-in socket assembly located below the gum line in Kownacki U.S. Pat. No. 5,302,125 (prior art);

FIG. 2 is a cross sectional view of a cylindrical expansion abutment from Brajnovic U.S. Pat. No. 7,175,434 (prior art);

FIG. 3 is cross sectional view of elements of the adjustable locking abutment;

FIG. 4 a is an cross sectional view of the apparatus with the substructure sleeve and implant adjustments;

FIG. 5 is a detailed isometric view of the apparatus;

FIG. 6 is an exploded view of the ball lock segments;

FIG. 7 is an isometric view of the ball lock loosely assembled upon the abutment and implant;

FIG. 8 is a cross sectional view of the loosely assembled ball lock apparatus;

FIG. 9 is another isometric exploded view of an alternate ball lock assembly; and,

FIG. 10 is an exploded view of the upper washer and several ball segments.

### A DETAILED DESCRIPTION OF THE DRAWINGS

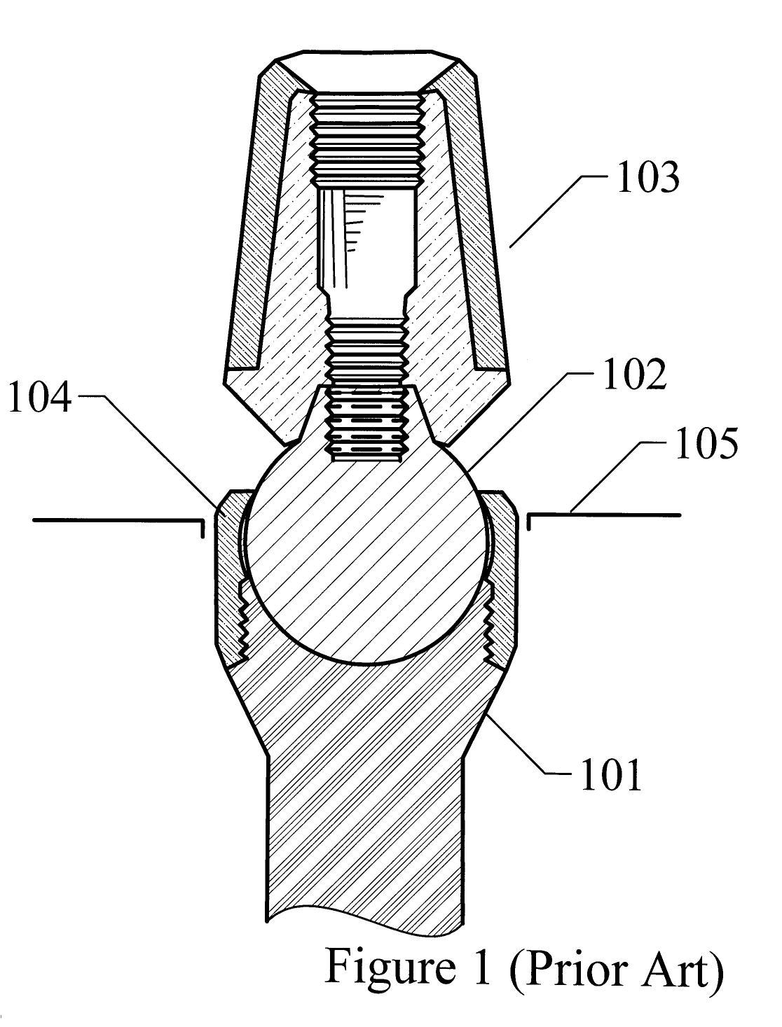

In FIG. 1 (Kownacki U.S. Pat. No. 5,302,125), cited as prior art, an implant 101 and abutment 103 are shown with the soft tissue line 105 approximating where the underlying adjustment is located. The ball assembly 102 is held in place by tightening a cap-like structure 104. The current invention offers a substantial improvement by avoiding the soft tissue while making compensating adjustments. Hygiene is compromised in the prior art. Furthermore, alignment is only possible in an arc centering on the midpoint of the ball. Adjustments for parallel displacement are not possible. Adjustment in the vertical placement of a substructure sleeve is not possible with this prior art.

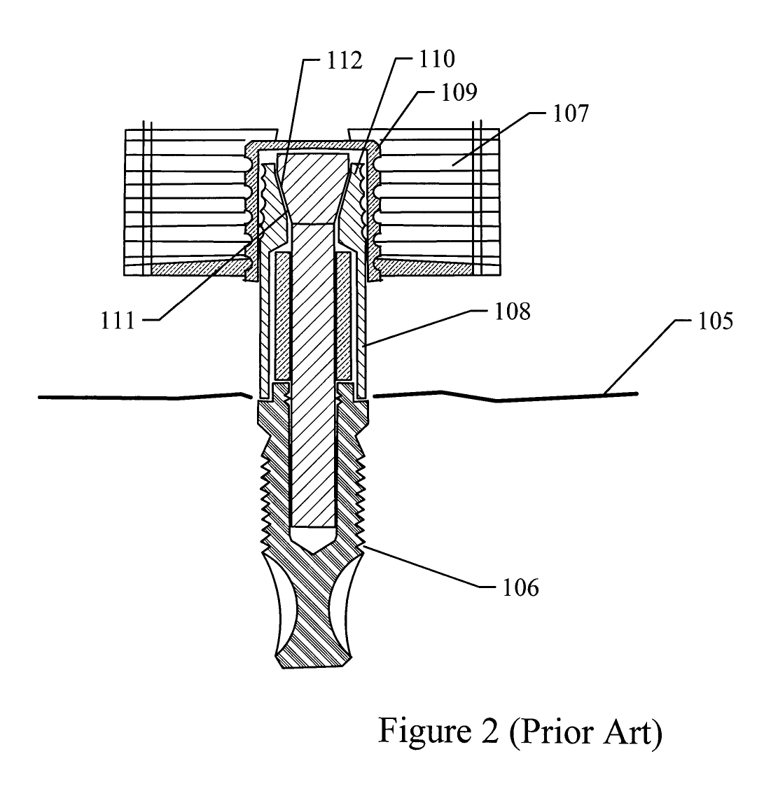

Likewise, the prior art in FIG. 2 (Brajnovic U.S. Pat. No. 7,175,434) teaches an implant 106 located below the soft tissue line 105 with an abutment 108 having a cylindrical expanding head 110. The expanding head of the cylindrical abutment slides within the substructure sleeve 109 of the bridge assembly 107. Wedge-like portion of the screw head 1111 bears against the inner surface of the abutment expanding head at 112 to lock the abutment within the substructure sleeve. The adjustment is along the vertical axis of the implant only. No offset or angular displacement is compensated by this prior art design. If off-centered, the expansion head of this design does not bear against the inner wall of the substructure sleeve with equal force around the complete inner circumference. Thus, this prior art relies upon a non-reversible permanent distortion of the substructure sleeve to achieve a true lock. The current invention, by centering the locking mechanism, applies equal forces without permanent distortion of the sleeve, while adjusting for lateral, angular and vertical misalignment. This allows for the reversible removal by loosening the locking screw.

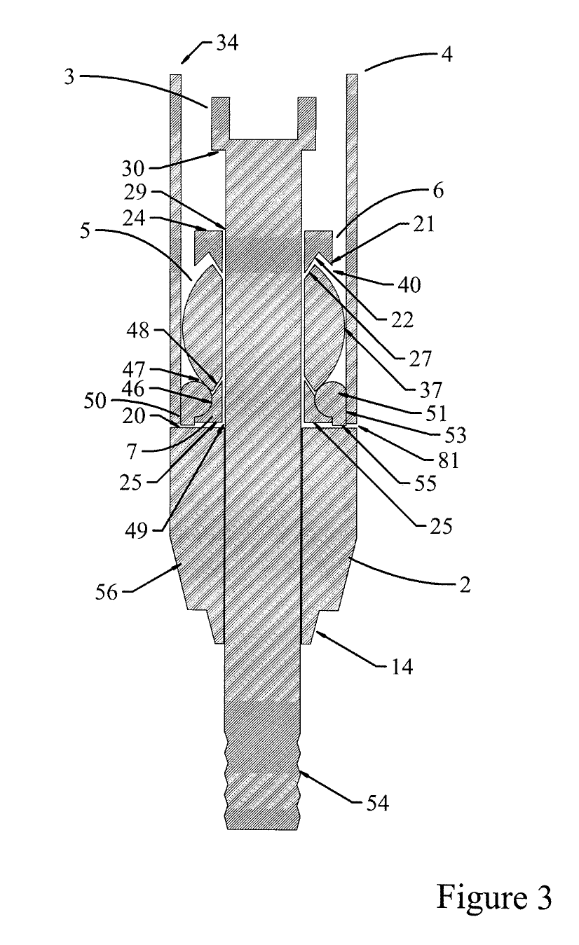

As detailed in FIG. 3, the ball assembly of this invention sliding within the straight-walled cylindrical substructure sleeve interior allows vertical adjustment along the central axis of the implant and abutment. The diameter of the abutment upper surface 20 being larger than the inner diameter 34 of the substructure sleeve prevents the ball assembly from dropping through during installation.

The enlarged through-holes 29 and 49 in the upper and lower wedge washers allow for lateral adjustment of the ball lock assembly in a plane perpendicular to the axis of the implant and abutment. The spherical ball segments 5 will lock within the substructure sleeve 4 at any small angle. All three of these adjustments act independently or in concert in this invention.

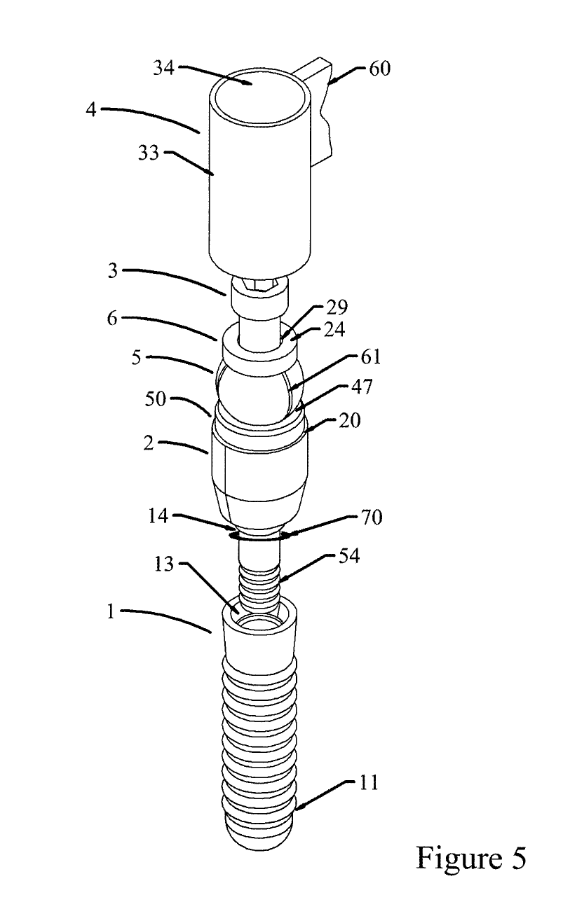

Cross sectional view, FIG. 3, shows a segmented ball locking apparatus consisting of an upper wedge washer 6, caged ball segments 5, lower wedge washer 7 and gasket 50 loosely seated upon abutment 2. Retaining screw 3 is shown in the central through-hole in these elements. Upon tightening of the screw, the following happens. The flat underside 30 of the screw head bears against the upper wedge washer's flat upper surface 24. Gap 29 allows lateral motion of the washer. Projection 22 of the upper wedge washer bears upon the recessed surface 27 of the ball segments 5. Rim 21 on the upper washer prevents the loss of the ball segments prior to the full tightening of the retaining screw. The lower recessed surface 48 of the ball segments bear against the upper projection of the lower wedge washer 7. The flat lower surface 25 of the lower wedge washer bears against the flat upper surface 20 of the abutment 2. The ball segments expand outward and lock within the substructure sleeve 4 at the greatest circumference 37 of the ball segments. FIG. 5 shows the segmented ball lock 5 with segment gaps 61. The optimum number of segments is three in number but other divisions of the spherical ball lock are possible. In FIG. 3, the gap 49 between the lower wedge washer 7 central through hole and the shaft of screw 3 allows for lateral displacement for off axis alignment.

In FIG. 3, gasket 50 surrounds wedge washer 7 and is compressed by the downward and outward motion of the ball segments 5. The toroidal portion 51 of the gasket seals against the ball segments in region 47 and the lower wedge washer circumferential concave surface 46. The outer skirt 53 of the gasket 50 compression seals against the inner wall 34 of the hollow substructure sleeve 4. Lower surface 55 of the gasket skirt seals in compression against the flat upper surface 20 of the abutment. The gasket forms a watertight seal, even if axial or angular displacement occurs.

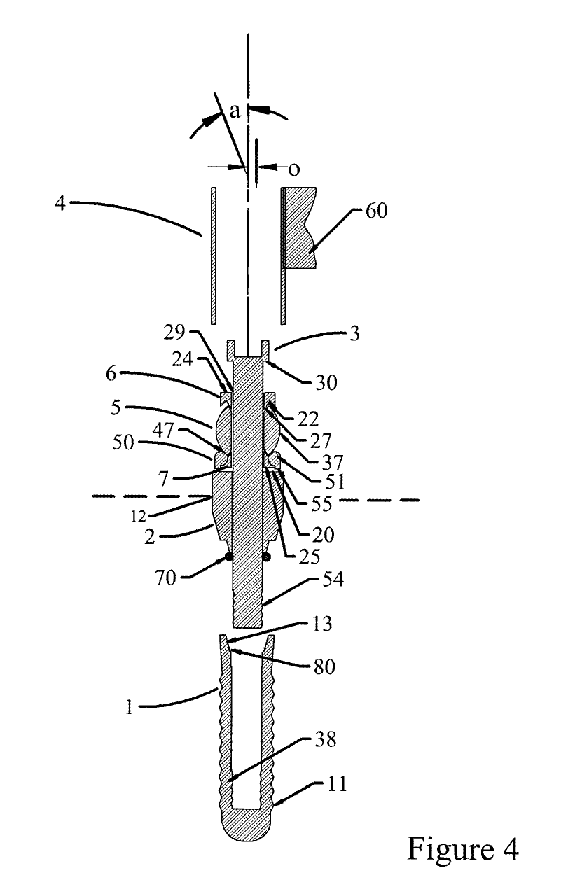

The substructure sleeve has an inner diameter 34 that is smaller than the diameter of the flat top 20 of the abutment to prevent the ball lock assembly from dropping through the substructure sleeve during installation in the maxilla. Since misalignment is expected to be less than a millimeter, little or none of the gasket will be visible. The abutment has a transition region 56 to mimic the natural tooth emergence through the gum tissue. All of the ball locking mechanism is located above the soft tissue line 12 as detailed in FIG. 4. Access to the screw driving means to actuate the locking mechanism is through the occlusal surface of the prosthesis. In FIG. 5, conic region 14 on the abutment mates with a matching recess 13 on the implant 1. In FIG. 4, internal threads 38 in the blind central hole of the implant mate with the retaining screw threads 54.

As shown if FIG. 3, the outer diameter of the substructure sleeve is the same as the diameter of the upper flat surface 20 of the abutment to provide as smooth a transition as possible between the abutments and the undercase. The skirt 52 of the silicone rubber gasket 50 completes the transition by bulging out to fill any small gap 81 caused by misalignment.

In an embodiment of this invention as detailed In FIG. 4, one of several implants 1 is placed in the maxillary or mandibular jawbone. External threaded region 11 anchors the implant. Substructure sleeve 4 with a partly displayed connecting substructure or bar 60 is telescoped over the ball locking mechanism while the screw 3 with the ball lock is loosely in place. Each ball lock screw is tightened in turn to lock the prosthesis in place. A small plug of cotton or sponge (not shown) protects the driving recess in the screw head and a resin compound is used to fill the access hole in the occlusal surface.

In FIGS. 3 and 4, an identical gap 29 exists for both wedge washers 6 and 7. These gaps allow the wedge washers to slide laterally to seat with bearing surfaces 27 of the several segments of the ball lock 5. The bearing surfaces of the upper and lower wedge washers slide against portions of the recessed surfaces of the ball segments, thus wedging the ball segments outward against the inner surface 34 to lock within substructure sleeve 4. These gaps 29 and 49 allow the upper and lower washers to center the ball lock within the substructure sleeve. This centering allows each segment to exert equal and intimate contact pressure in a ring or “great circle” 37 at the maximum diameter of the ball. This intimate locking contact still exists if the substructure sleeve is misaligned at an angle ‘a’. Lateral displacement ‘o’, off-axis from the centerline is compensated for by the through-holes in the washers being of a larger diameter than the retaining screw shaft. This allows the flat surfaces of each washer to shift laterally to center the ball within the substructure sleeve to equalize the locking force exerted by each ball segment.

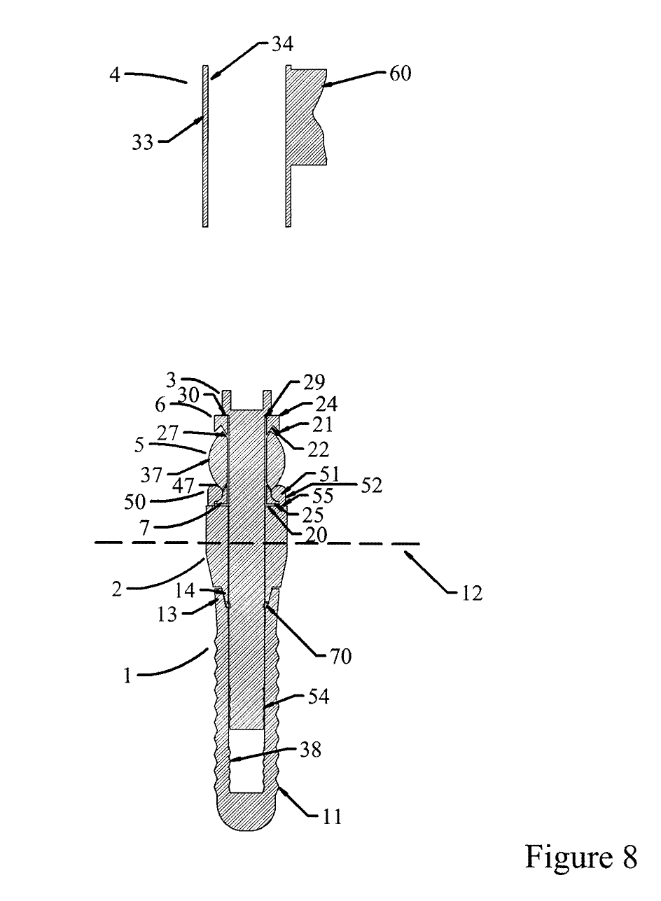

Retaining rims 21 on the upper wedge washer and gasket 50 surrounding the lower wedge washer 7 prevent the loss of the ball lock segments. FIG. 3 shows the upper wedge washer 6 has a rim 21 that holds the segments of the ball 5 loosely in place during assembly prior to the full tightening of the screw 3. The segmented ball parts cannot fall out and be lost and yet the ball lock slides easily into each sleeve on a multi-abutment undercase. As shown in FIGS. 5, 8 & 9, for packaging and sterilization, the screw, upper and lower washer, gasket and the ball segments are loosely pre-assembled with a retaining o-ring 70 fitted tightly upon the retaining screw shaft. The o-ring prevents the loss of the ball segments during the installation of the ball lock assembly. O-ring 70 made of silicone rubber or other biocompatible polymer fits within the screw recess of the implant fixture 1. The Parker Hannafin O-Ring Company of Lexington, Ky. can provide O-rings in these modest dimensions in several materials including biocompatible silicone elastomer.

Each implant abutment 2 is held in place with a retaining screw 3 that also serves the purpose of locking the spherical ball segments in the sleeve. The screw is slipped through a set of wedge washers 6 and 7 and a sectioned spherical ball lock 5. While the screw is loosely tightened, the spherical ball lock slips easily into the substructure sleeve 4 on an undercase to offer a combination of three types of adjustment. The sleeve 4 can move vertically up and down over the spherical ball lock 5. The sleeve can tilt at an angle (marked as angle ‘a’ in FIG. 4) with respect to the axis of the implant and the attached abutment. Also, off-axis compensation is accomplished for those implants that have parallel axes but whose centerlines do not match the centerlines of the sleeves in the undercase. Minor differences in surgical and laboratory construction results are thereby compensated for by a combination of these several adjustments. The adjustment range for vertical alignment is anticipated to be approximately 1 mm. Angular adjustment of a few degrees and parallel-axis misalignment of +/−0.2 mm can be accommodated by the ball lock assembly.

When the screw 3 is tightened the segments of the ball are forced outward and grip the inner surface of the sleeve 34 along a “great circle” 37 at the maximum diameter of the ball. When the substructure sleeve and the axis of the implant are at an angle, the ball segments mate with the inner surface of the substructure sleeve along the maximum circumference of a different “great circle”. The outer spherical surface of the ball segments in region 37 is provided with a rough or textured hard surface to better grip the inner wall of the sleeve. When the screw is tightened, the flat underside of the screw head 30 is forced against the flat surface 24 of the upper wedge washer 6. The downward facing wedge projection 22 of the upper washer, in contact with mating surfaces 27 on the ball segments, drives the segments 5 of the ball outward. Similarly, a lower wedge washer with an upward facing projection 48 is in mating contact with lower recess of the ball lock segments 5, and forces the segments of the ball lock outward against the inner wall of the substructure sleeve. The flat lower surface 25 of the lower wedge washer 7 bears against the flat upper surface 20 of the abutment 2. The through-holes in the wedge washers are larger than the shaft of the screw to allow for lateral movement. This allows the ball lock to center within the substructure sleeve to compensate for off-axis misalignment of the sleeves in the undercase. When centered, the segments of the ball are forced with equal pressure against the inner wall of the sleeve. The radius of curvature or diameter of the ball closely matches the inner diameter of the sleeve. Gaps 40 allow some “play” for the wedging action to occur. When the ball segments are forced outward, they bite into the sleeve wall and hold by means of the roughened surface on the outer spherical surface of the ball segments. The hard outer surface of the ball lock segments can be provided with small sharp peaks or asperities to bite into the inner surface of the substructure sleeve. Depending on the angle of incline of mating surfaces 22 and 27, a multiplying of the screw torque force to ball holding force occurs. Under proper torque, the locking mechanism is reversible. A loosening of the screw allows for the removal of the ball lock mechanism from within the substructure sleeve. The screw 3 is provided with a small fillet where the underside of head attaches to the shaft to prevent stress cracking. The fillet does not interfere with the lateral adjustment of the ball lock assembly.

FIG. 5 is an exploded isometric view of the preferred embodiment of the invention. Implant 1 is shown with external threads 11 and internal tapered locking means 13. Retaining screw 3 has threads 54 that mate with internal threads 38 (not shown) of the implant. Projection 14 of abutment 2 mates with the internal locking means 13. Flat upper surface 20 of the abutment is shown with gasket 50 in place. Ball segments 5 rest upon gasket seam 47. Gaps 61 between the ball segments are shown. Upper washer 6 rests upon and retains the ball segments. The flat underside of screw 3 bears against the upper washer's flat upper surface 24. Gap 29 acts to allow the washers, ball segments and gasket to center within the substructure sleeve 4. Inner surface 34 of the substructure sleeve is a slip fit over the ball segments and gasket prior to the tightening of the retaining screw at full torque. The external surface 33 of the substructure sleeve is shown connected to a bar 60 linked to another substructure sleeve (not shown).

The resilient gasket 50 of biocompatible synthetic rubber or flexible silicone is compressed downward and outward at the seam 47 by the ball segments. Bottom surface 55 of skirt 52 of the gasket is forced downward in compressed contact with surface 20 of the abutment upon tightening of the screw. The outer rim of the skirt 52 of the gasket is compressed outward to form a tight seal against the inner surface 34 of the substructure sleeve 4. Angular misalignment of a few degrees is allowed by the flexible gasket without compromising the hygienic seal. This completes the circumferential seal keeping all fluids and bacteria from entering the mechanism.

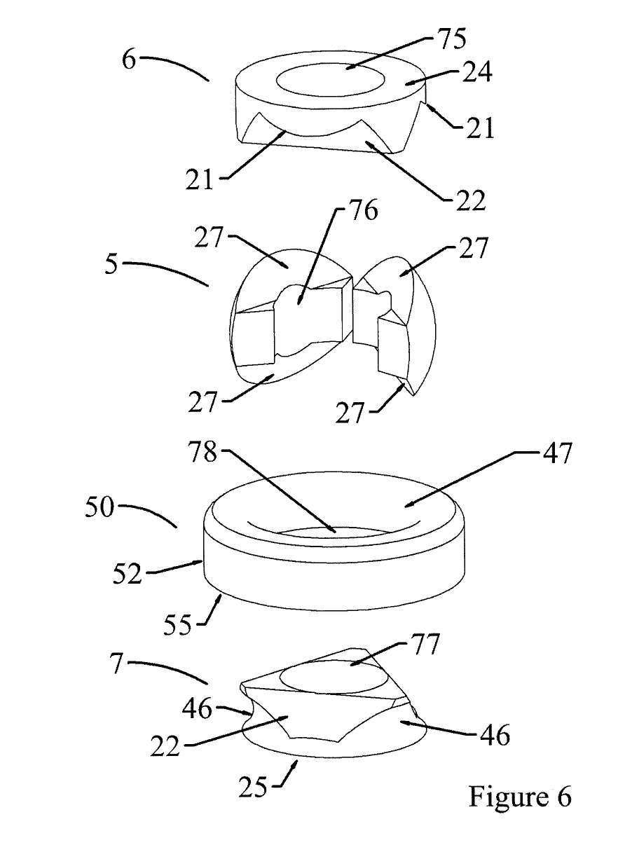

FIG. 6 shows a ball lock 5 of three segments (with one removed for clarity), one of which is labeled 5a. These ball segments have an upper recessed surface 27 and a lower recessed surface 27 to mate with the upper and lower wedge washers respectively to accomplish the wedging outward of the ball segments. Inner through holes 75, 76, 77 and 78 are of a diameter greater that that of the retaining screw shaft leaving lateral adjustment gaps. Vertical gaps 61 (shown if FIG. 5) widen upon tightening the screw. Outer spherical surface 37 locks against the inner bore 34 of the substructure sleeve.

The toroidal portion 51 of the gasket seals against the outer surface of the ball segments in region 47 and the lower wedge washer circumferential concave surface 46. The outer skirt 52 of the gasket 50 compression seals against the inner wall 34 of the hollow substructure sleeve 4. Lower surface 55 of the gasket skirt seals in compression against the flat upper surface 20 of the abutment.

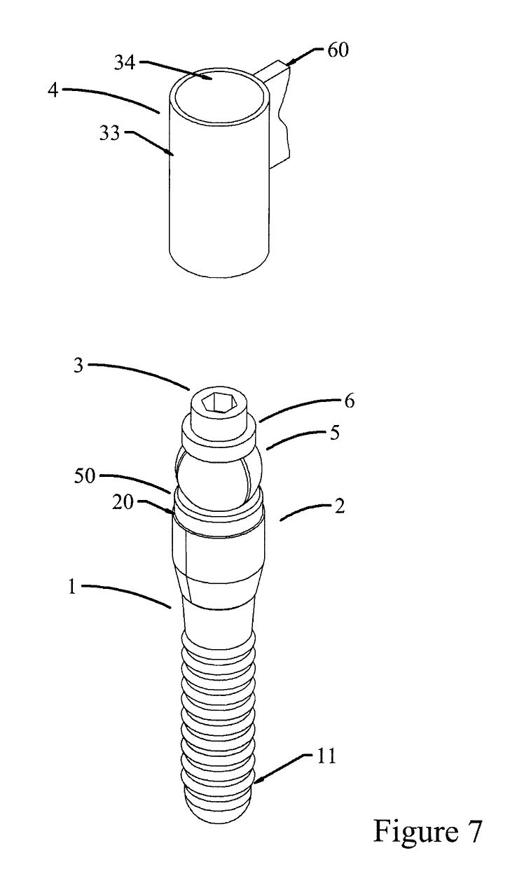

FIG. 7 is an assembled view of the ball lock mechanism on the implant 1 with abutment 2 in place. Gasket 50 surrounds lower wedge washer 7 (not seen) and bears against and retains ball segments 5. Wedge washer 6 bears against the upper surfaces of and retains the ball segments 5. Screw 3 loosely holds the ball lock assembly while the substructure sleeve 4 is slid over the assembly. An interconnection structural bar 60 is partially shown. Upon tightening the screw to a working torque of 20 to 35 N-cm, the ball segments are forced outward and lock within the sleeve inner surface 34.

FIG. 8 shows a cross sectional view of the assembled ball lock mechanism. All adjustments are located above the soft tissue represented by dotted line 12. Screw 3 with threads 54 mate with internal threads 38 of implant 1. Unclocked conic recessed surface 13 of the implant mates with conic projection 14 of the abutment 2 offering a watertight transition through the soft tissue. O-ring 70 is packaged with the ball lock assembly and holds the abutment 2, the lower wedge washer 7, the gasket 50, the ball segments 5, and the upper wedge washer 6 on the screw shaft. The elements of the ball lock are in close contact, but still can shift relative to each other. The ball lock segments have a outer radius of curvature that is identical to the inner diameter 34 of the substructure sleeve within manufacturing tolerances. While the assembly is loosely combined, the gaps between the ball segments are narrow and allow the ball segments to slip easily into the sleeve. Upon tightening the retaining screw 3 the gaps between the segments widen and the outer radius of curvature of the ball segments form an intimate full locking arc with the internal radius of curvature of the substructure sleeve.

FIG. 8 also shows the necessary gaps that allow the components to shift to accommodate for misalignment prior to locking. Gap 29 allows for the lateral motion of the upper and lower wedge washers around the screw shaft. This compensates for off-axis misalignment between parallel abutments. Flat surfaces 30 and 24 slide over each other. Similarly, flat surfaces 20 and 25 slide over each other to adjust for misalignment in the horizontal plane.

Also, in FIG. 8, Gasket 50 has an outer rim 52 that expands and locks within sleeve 4 when gap 47 is compressed outward by ball segments 5. Ball segments also bear down to circumferentially seal gasket 50 surface 55 to the flat surface 20 of abutment 2. In most cases, less than a millimeter of the silicone rubber gasket is visible. The silicone rubber, molded elastomeric gasket is available as a clear flexible compound as a custom item from Parker O-ring Company.

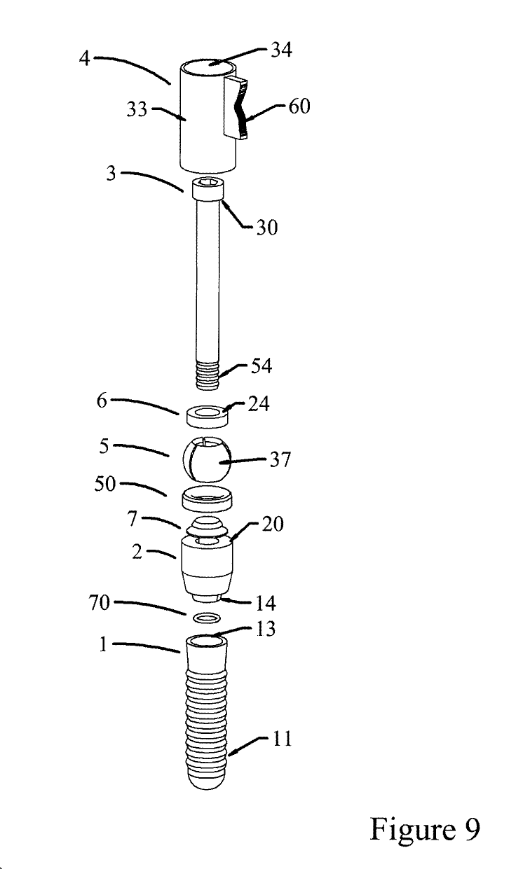

FIG. 9 shows another exploded view of the components of an alternate embodiment of the ball lock assembly. Implant 1 is shown with threads 11 and internal mounting recess with conic region 13. O-ring 70 is used to hold all the components on the shaft of screw 3. A recess 80 within the implant accommodates this o-ring, as shown in FIG. 4. These components are abutment 2 with matching conic projection 14 fitting within recess 13, wedge washer 7, sealing gasket 50, ball lock segments 5 with rough surface 37, and upper wedge washer 6. Flat surfaces 24 and 30 slide past each other. The flat surface on the lower side of wedge washer 7 glides over flat surface 20. When screw 3 is tightened to the required torque, ball segments 5 expand outward to lock within cylindrical opening 34 of the sleeve 4 along a great circle around the circumference of the ball segments.

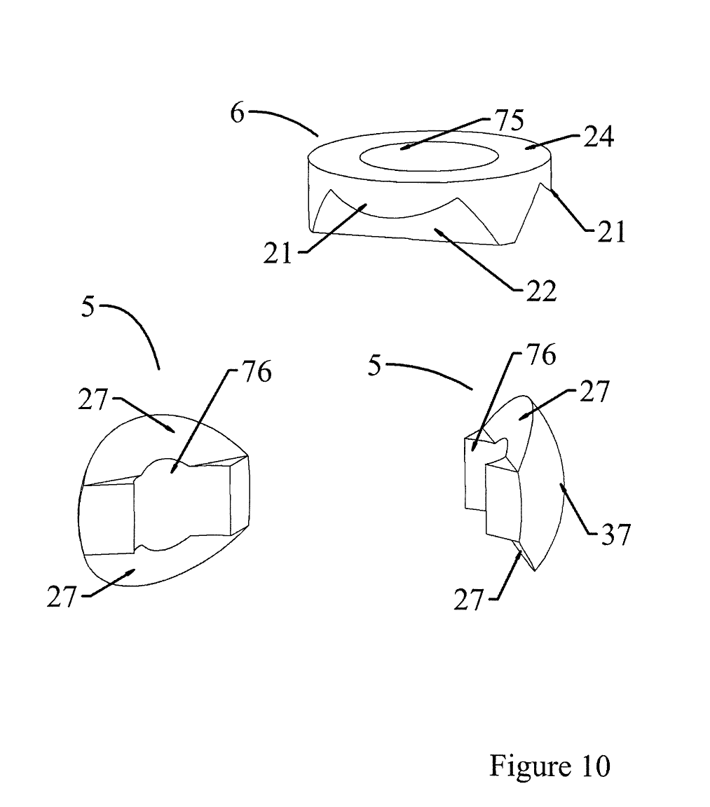

In the preferred embodiment, FIG. 10 is an exploded view of the washer and ball segments with one of the ball segments removed for clarity. Upper washer 6 has a through hole 75 and a flat upper surface 24. Inclined flat surfaces 22 mate with flat surfaces 27 and wedge out ball segments 5 outward to lock the rough spherical outer surface 37 against the inner diameter of the sleeve. Projections 21 serve to prevent the loss of the ball segments in the pre-assembled ball lock apparatus. The washers and ball segments are easily manufactured with standard tooling. Ball segment through-hole passageway 76, and through holes 75 and 77 in the upper and lower wedge washers are larger than the diameter of the retaining screw and allow for lateral shift. The lower wedge washer 7 is not shown.

The metal mechanical parts of the ball lock assembly all bear against each other in metal-to-metal compression to resist loss of locking action. Additional thread locking means, though not shown, between screw threads 54 and internal implant threads 38 are intended for a secure lock.

In another embodiment of the invention, the ball segments can be manufactured with a thin metal bridge between each segment. These bridges are snapped apart under the tightening installation force.

In an alternate embodiment the ball segments are held in place with a silicone rubber ring. Each ball segment has an internal retaining groove to grab the silicone rubber ring that slips over the shaft of the screw.

What is claimed is:

1. A dental apparatus for aligning and locking an implant assembly to an overcase comprising
a sectioned sphere with through hole and upper and lower indentations divided into at least two segments, an upper washer with downward facing projection and a flat upper surface,
a lower washer with upward facing projection and a lower flat surface,
a screw having a flat surface under the screw head, an implant abutment having a flat upper surface, and a substructure sleeve;
said projections of said upper and lower washers bearing against said respective lower and upper indentations in said sectioned spherical segments;
said sectioned sphere expanding in diameter to lock within said substructure sleeve upon tightening of said screw.

2. An apparatus as cited in claim 1 comprising a rough, frictional surface on the outer surfaces of said spherical segments.

3. An apparatus as cited in claim 1 comprising said upper washer having a retaining rim to secure said spherical segments.

4. An apparatus as cited in claim 1 comprising thin metal bridging links to secure said spherical segments, said thin metal bridging links snapping apart upon tightening said screw to lock said ball lock assembly.

5. An apparatus as cited in claim 1 comprising a resilient o-ring snapping into an internal groove in said through hole of said sectioned sphere, thereby securing said spherical segments around said screw shaft.

6. A dental apparatus for aligning and locking an implant assembly above the gum line to an overcase comprising
a sectioned sphere with through hole and upper and lower indentations divided into at least two segments,
an upper washer with downward facing projection,
a resilient gasket,
a lower washer with upward facing projection and a circumferential concave recess,
a screw having a flat surface under the screw head,
an implant abutment having a flat upper surface,
and a substructure sleeve;
said projections of said upper and lower washers bearing against said respective lower and upper indentations in said sectioned spherical segments;
said sectioned sphere expanding in diameter to lock within said substructure sleeve upon tightening of said screw;
said resilient gasket residing between said sectioned spherical segments and said lower washer;
said resilient gasket upon expansion of said ball segments sealing all gaps between said lower washer, said ball segments, said abutment and said substructure sleeve upon the tightening of said screw.

7. A dental apparatus as cited in claim 6, comprising a roughened surface on the exterior spherical surfaces of said ball segments.

8. An apparatus as cited in claim 6 comprising said upper washer having a retaining rim to secure said spherical segments.

9. An apparatus as cited in claim 6 comprising thin metal bridging links to secure said spherical segments, said thin metal bridging links snapping apart upon tightening said screw to lock said ball lock assembly.

10. An apparatus as cited in claim 1 comprising a resilient o-ring snapping into an internal groove in said through hole of said sectioned sphere, thereby securing said spherical segments around said screw shaft.

11. An apparatus as cited in claim 1 comprising an o-ring slipped over the lower portion of said screw shaft to loosely retain the ball lock assembly.

12. An apparatus as cited in claim 1 comprising a thread locking means.
